(19) United States
(12) Patent Application Publication
(10) Pub. No.: US 2006/0261758 A1
(43) Pub. Date: Nov. 23, 2006

(54) Limited open circuit voltage ballast

(76) Inventor: Clinton H. Mason, Hanover Parkan, IL (US)

Correspondence Address: PHILIPS INTELLECTUAL PROPERTY & STANDARDS, P.O. BOX 3001, BRIARCLIFF MANOR, NY, 10510, US

(21) Appl. No.: 10/557,976

(22) PCT Filed: May 10, 2004
(86) PCT No.: PCT/IB04/01588

§ 371 Date: Nov. 17, 2005

Related U.S. Application Data
(60) Provisional application No. 60/471,701, filed on May 19, 2003.

(51) Int. Cl. H05B 37/00

(52) U.S. Cl. 315/312

(57) ABSTRACT

A lighting system employs a pair of ballast input stages (21) operable to oscillate at different oscillating frequency (f1, f2) upon an initial powering of the ballast input stages (21). The lighting system further employs a pair of ballast output stages (23) for establishing an open circuit voltage across the ballast output stages (23) in response to an absence of a loading of lamps (10) across the ballast output stages (23). The light system further employ means for, subsequent to the initial powering of the ballast input stages (21) and in response to the absence of the loading of the lamps (10) across the ballast output stages (23), impeding any parasitic loading across the ballast output stages (23) from phase locking the oscillating frequencies (f1, f2).

The present invention generally relates to lamp ballasts. The present invention specifically relates to a limitation of an open circuit voltage of a plurality of ballast output stages connected in series.

FIG. 1 illustrates a known lamp ballast 20 for igniting and powering a pair of lamps 10. Ballast 20 has a ballast input stage 21 employing an oscillator 22 for driving a ballast output stage 23 having a known arrangement of a tank resonant capacitor C1, a current limiting capacitor C2, and a tank resonant transformer including a primary winding PW1 and secondary windings SW1-SW4. Typically, when lamps 10 are switched to a no-load condition (i.e., lamps 10 are switched out of ballast 20 or in a pre-ignition phase), an open circuit voltage across ballast output stage 23 complies with UL requirements. However, in some lighting applications, it is desirable to connect ballast output stages 23 of two or more lamp ballasts 20 in series to thereby power additional lamps 10. Thus, in dependence upon a topology of balance input stages 21, there may be need to limit an open circuit voltage across the series connection of ballast output stages 23 to ensure compliance with UL requirements and any other applicable safety standards.

The present invention provides an open circuit voltage limiting technique for a series connection of ballast output stages.

One form of the present invention is a lighting system employing a pair of ballast input stages operable to oscillate at different oscillating frequencies upon an initial powering of the ballast input stages. The lighting system further employs a pair of ballast output stages for establishing an open circuit voltage across the ballast output stages in response to an absence of a loading of lamps across the ballast output stages. The light system further employ means for, subsequent to the initial powering of the ballast input stages, impeding any parasitic loading across the ballast output stages from phase locking the oscillating frequencies in response to the absence of the loading of the lamps across the ballast output stages.

The foregoing form as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

FIG. 1 illustrates a lamp ballast known in the prior art,

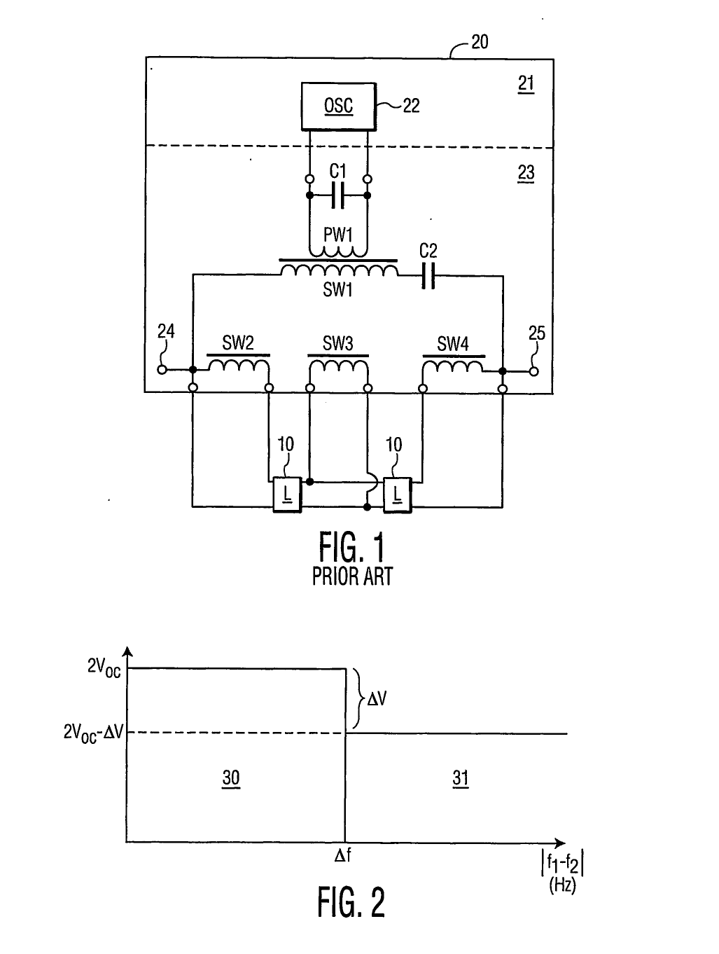

FIG. 2 illustrates a graphical representation of a voltage limiting technique of the present invention;

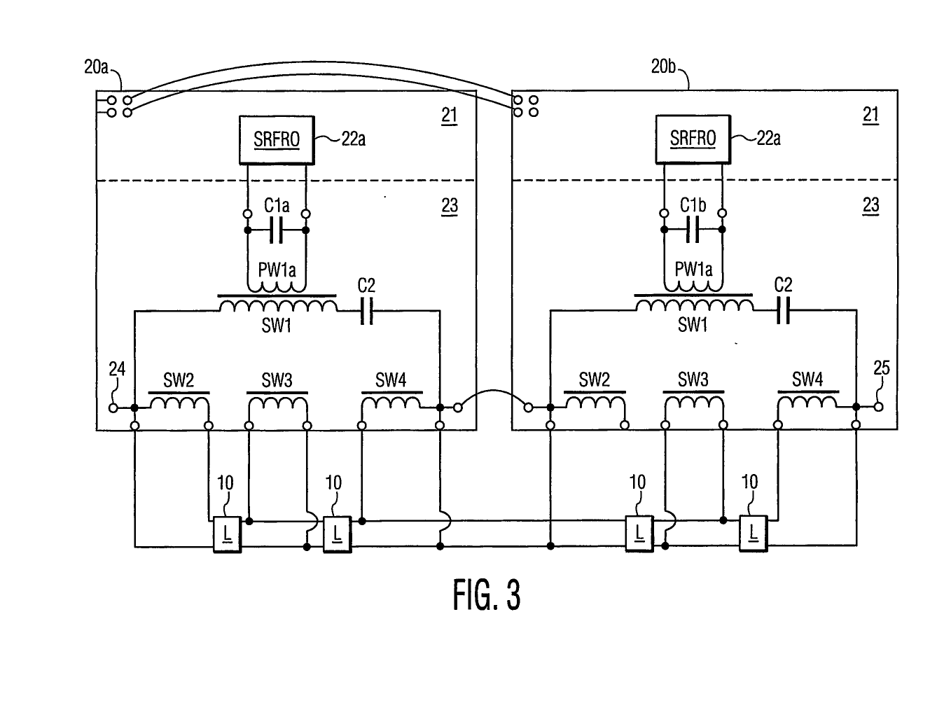

FIG. 3 illustrates a series connection of lamp ballasts in accordance with a first embodiment of the present invention;

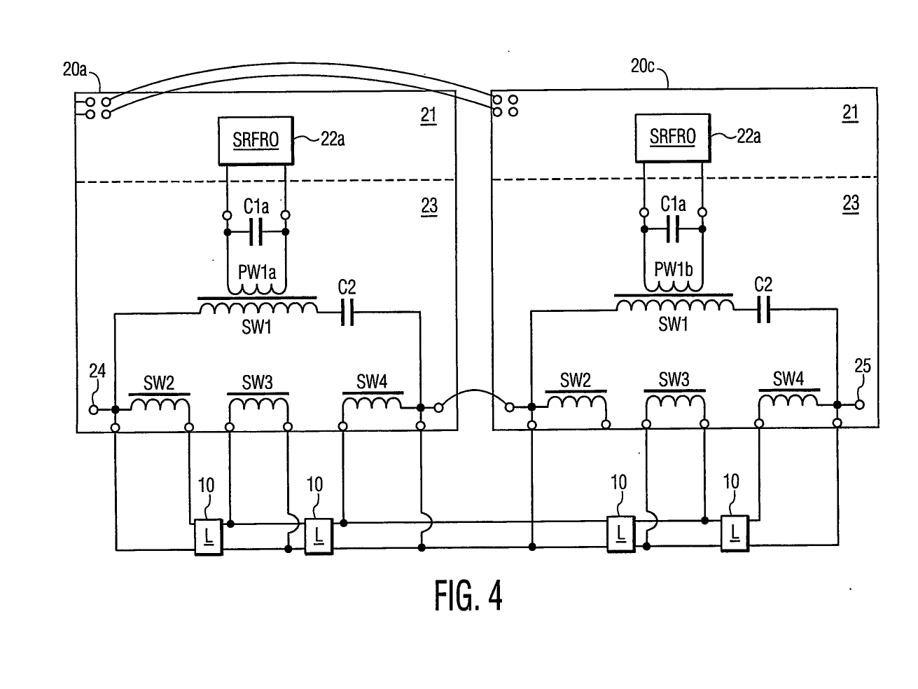

FIG. 4 illustrates a series connection of lamp ballasts in accordance with a second embodiment of the present invention;

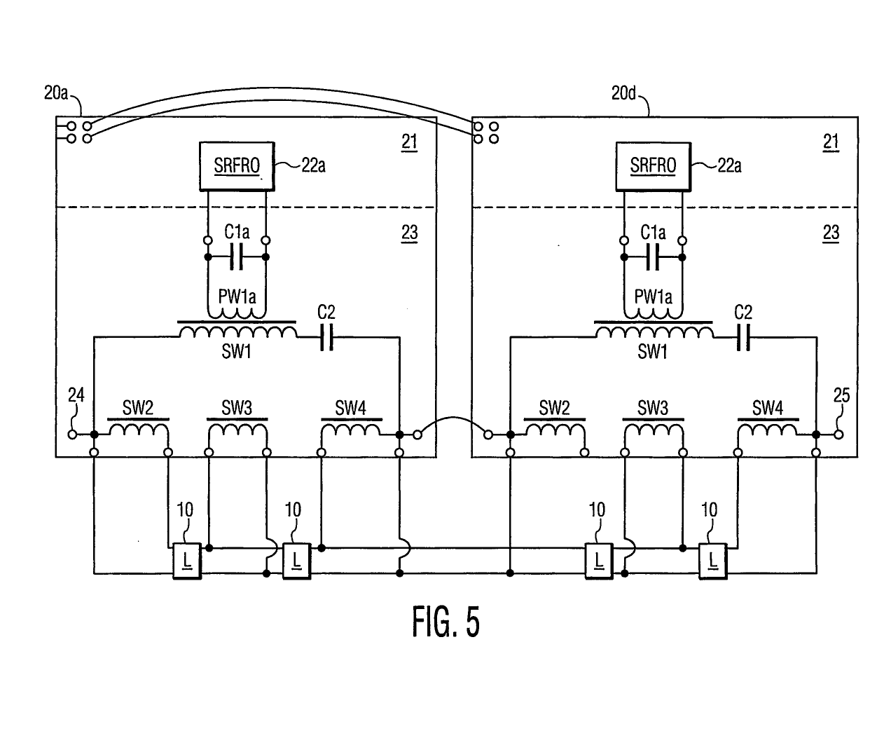

FIG. 5 illustrates a series connection of lamp ballasts in accordance with a third embodiment of the present invention; and

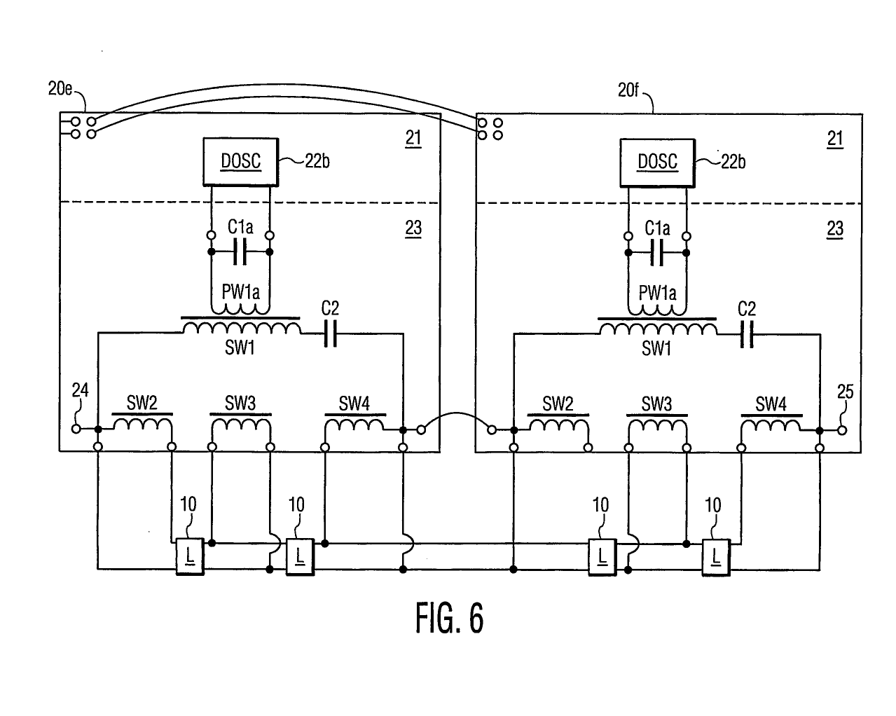

FIG. 6 illustrates a series connection of lamp ballasts in accordance with a fourth embodiment of the present invention.

As illustrated in FIG. 2, the inventor discovered two distinct operation regions 30 and 31 of lamp ballasts 20 (FIG. 1) having a series connection of ballast output stages 23 (FIG. 1) due a sensitivity of oscillator 21 (FIG. 1) to parasitic loading. Operation regions 30 and 31 will subsequently be described in the context of a series connection of two (2) output ballast stages 23 to facilitate an understanding of operation regions 30 and 31. From this description, those having ordinary skill in the art will appreciate the how a series connection of three (3) output ballast stages 23 function in the operation regions 30 and 31.

Operation region 30 is defined by an absolute difference between an oscillating frequency f₁ and an oscillating frequency f₂ of a pair of ballast input stages 21 (FIG. 1) upon initial powering being within a range extending between 0 Hz to a cutoff frequency differential Δf: Within this operation region 30, a total rms of an open circuit voltage across the ballast output stages 23 during a no-load condition of the lamps is an open circuit voltage Voc supplied individually by the ballast output stages 23. From the investigation, the inventor ascertained that the total rms 2V_{OC} of the open circuit voltage within operation region 30 resulted from a leakage current from a parasitic loading of the output leads 24, 25 of the series connected ballast output stages 23 would force a phase lock of oscillating frequency f₁ and oscillating frequency f₂.

Operation region 31 is defined by the absolute difference between oscillating frequency f₁ and oscillating frequency f₂ of a pair of ballast input stages 21 (FIG. 1) upon initial powering being greater than the cutoff frequency differential Δf. Within this operation region 31, total rms of an open circuit voltage across the ballast output stages 23 during a no-load condition of the lamps is less than the open circuit voltage 2V_{OC} by a voltage differential ΔV. From the investigation, the inventor ascertained that the total rms 2V_{OC}−ΔV of the open circuit voltage within operation region 31 resulted from the leakage current from the parasitic loading of the output leads 24, 25 of the series connected ballast output stages 23 being unable to force a phase lock of oscillating frequency f₁ and oscillating frequency f₂.

It is advantageous to operate the lamp ballasts in region 31 whenever the total rms 2V_{OC} of region 30 exceeds UL requirements and total rms 2V_{OC}−ΔV of region 31 is below UL requirements. Thus, the inventor of the present invention performed a considerable amount of investigation into discovering a technique for eliminating the cutoff frequency differential Δf to thereby limit the open circuit voltage across a series connection of ballast output stages 23 under any topology of ballast input stages 21. To this end, FIGS. 3-6 illustrate various embodiments for implementing the open circuit voltage limiting technique of the present invention for series connected ballast output stages 23.

FIG. 3 illustrates a version 20a and a version 20b of lamp ballast 20 (FIG. 1) for powering four lamps 10. Lamp ballasts 20a and 20b have their ballast input stages 21 coupled in parallel and their ballast output stages 23 coupled in series. Ballast input stages 21 employ a pair of self-resonating, free-running oscillators (“SRFRO”) 22a of any type having an absolute oscillating frequency differential greater than zero (0) upon an initial powering of oscillators 22a. To maintain this absolute oscillating frequency differential between oscillators 22a subsequent to the powering of oscillators 22a, ballast output stage 23 of lamp ballast 20a employs a tank resonant capacitor C1a and ballast output stage 23 of lamp ballast 20b employs a tank resonant capacitor C1b. A capacitive differential between capacitors C1a and C1b is chosen to impede any parasitic loading across ballast output stages 23 during a no-load condition of lamps 10 from phase locking the oscillating frequencies of ballast input stages 21.

In practice, the capacitive differential between capacitors C1a and C1b is dependent upon the sensitivity of oscillators 22a to the parasitic loading. Thus, the inventor is incapable of describing a preferred capacitance differential between capacitors C1a and C1b due to the essentially unlimited number of topologies of oscillators 22a as would be appreciated by those having ordinary skill in the art However, for each topology of oscillators 22a, a minimal capacitance differential between capacitors C1a and C1b can be ascertained by the generation of a beat frequency waveform at no load that shows the oscillating frequencies are not phase locked as would be appreciated by those having ordinary skill in the art.

FIG. 4 illustrates version 20a and a version 20c of lamp ballast 20 (FIG. 1) for powering four lamps 10. Lamp ballasts 20a and 20c have their ballast input stages 21 coupled in parallel and their ballast output stages 23 coupled in series. Ballast input stages 21 employ a pair of self-resonating, free-running oscillators (“SRFRO”) 22a of any type having an absolute oscillating frequency differential greater than zero (0) upon an initial powering of oscillators 22a. To maintain this absolute oscillating frequency differential between oscillators 22a subsequent to the powering of oscillators 22a, ballast output stage 23 of lamp ballast 20a employs a primary winding PW1a and ballast output stage 23 of lamp ballast 20b employs a primary winding PW1b. A inductive differential between primary windings PW1a and PW1b is chosen to impede any parasitic loading across ballast output stages 23 during a no-load condition of lamps 10 from phase locking the oscillating frequencies of ballast input stages 21.

In practice, the inductive differential between PW1a and PW1b is dependent upon the sensitivity of oscillators 22a to the parasitic loading. Thus, the inventor is incapable of describing a preferred inductance differential between PW1a and PW1b due to the essentially unlimited number of topologies of oscillators 22a as would be appreciated by those having ordinary skill in the art. However, for each topology of oscillators 22a, a minimal inductance differential between PW1a and PW1b can be ascertained by the generation of a beat frequency waveform at no load that shows the oscillating frequencies are not phase locked as would be appreciated by those having ordinary skill in the art.

FIG. 5 illustrates version 20a and a version 20d of lamp ballast 20 (FIG. 1) for powering four lamps 10. Lamp ballasts 20a and 20d have their ballast input stages 21 coupled in parallel and their ballast output stages 23 coupled in series. Ballast input stages 21 employ a pair of self-resonating, free-running oscillators (“SRFRO”) 22a of any type having an absolute oscillating frequency differential greater than zero (0) upon an initial powering of oscillators 22a. To maintain this absolute oscillating frequency differential between oscillators 22a subsequent to the powering of oscillators 22a, an air gap between primary winding PW1a and secondary windings SW1-SW4 of lamp ballast 20a is less than the air gap between primary winding PW1a and secondary windings SW1-SW4 of lamp ballast 20d. A air gap differential between resonant transformers is chosen to impede any parasitic loading across ballast output stages 23 during a no-load condition of lamps 10 from phase locking the oscillating frequencies of ballast input stages 21.

In practice, the air gap differential between the resonant transformers is dependent upon the sensitivity of oscillators 22a to the parasitic loading. Thus, the inventor is incapable of describing a preferred air gap differential between the resonant transformers due to the essentially unlimited number of topologies of oscillators 22a as would be appreciated by those having ordinary skill in the art. However, for each topology of oscillators 22a, a minimal air gap differential between the resonant transformers can be ascertained by the generation of a beat frequency waveform at no load that shows the oscillating frequencies are not phase locked as would be appreciated by those having ordinary skill in the art.

FIG. 6 illustrates a version 20e and a version 20f of lamp ballast 20 (FIG. 1) for powering four lamps 10. Lamp ballasts 20e and 20f have their input stages 21 coupled in parallel and their output stages 23 coupled in series. Lamp ballasts 20ae and 20f both employ a digitally controlled oscillator (“DSCO”) 22b of any type. The oscillators 22b are programmed to maintain an oscillating frequency differential between the oscillators 22b upon and subsequent to the powering of ballast input stages 21. The oscillating frequency differential is chosen to impede any parasitic loading across ballast output stages 23 during a no-load condition of lamps 10 from phase locking the oscillating frequencies of ballast input stages 21.

In practice, the oscillating frequency differential is dependent upon the sensitivity of oscillators 22b to the parasitic loading. Thus, the inventor is incapable of describing a preferred oscillating frequency differential due to the essentially unlimited number of topologies of oscillators 22b as would be appreciated by those having ordinary skill in the art. However, for each topology of oscillators 22b, a minimal oscillating frequency differential can be ascertained by the generation of a beat frequency waveform at no load that shows the oscillating frequencies are not phase locked as would be appreciated by those having ordinary skill in the art.

While the embodiments of the invention disclosed herein are presently considered to be preferred, various changes and modifications can be made without departing from the spirit and scope of the invention. For example, any combination of open circuit voltage limiting techniques illustrated in FIGS. 3-6 can be implemented in practice. The scope of the invention is therefore indicated in the appended claims, and all changes that come within the meaning and range of equivalents are intended to be embraced therein.

1. A lighting system, comprising:
a first ballast input stage (21) and a second ballast input stage (21), said first ballast input stage (21) operable to oscillate at a first oscillating frequency (f₁) and said second ballast input stage (21) operable to oscillate at a second oscillating frequency (f₂), the first oscillating frequency (f₁) and the second oscillating frequency (f₁) being dissimilar upon an initial powering of said first ballast input stage (21) and said second ballast input stage (21);
a first ballast output stage (23) and a second ballast output stage (23) connected in series, said first ballast output stage (23) in electrical communication with said first ballast stage (21) and said second ballast output stage (23) in electrical communication with said second ballast stage (21) to establish an open circuit voltage across said first ballast output stage (23) and said second ballast output stage (23) in response to an absence of a loading of a plurality of lamps (10) across said first ballast output stage (23) and said second ballast output stage (23); and
means for, subsequent to the initial powering of said first ballast input stage (21) and said second ballast input stage (21) and in response to the absence of the loading of the plurality of lamps (10) across said first ballast output stage (23) and said second ballast output stage (23), impeding any parasitic loading across said first ballast output stage (23) and said second ballast output stage (23) from phase locking the first oscillating frequency (f₁) and the second oscillating frequency (f₂)

2. A lighting system, comprising:
a plurality of ballast input stages (21) operable to oscillate at various oscillating frequencies (f₁,f₂), the oscillating frequencies (f₁,f₂) being dissimilar upon an initial powering of said plurality of ballast input stages (21);
a plurality of ballast output stages (23) connected in series, said plurality of ballast output stages (23) is in electrical communication with said plurality of ballast input stages (21) to establish an open circuit voltage across said plurality of ballast output stages (23) in response to an absence of a loading of a plurality of lamps (10) across said plurality of ballast output stages (23); and
means for, subsequent to the initial powering of said plurality of ballast input stages (21) and in response to the absence of the loading of the plurality of lamps (10) across said plurality of ballast output stages (23), impeding any parasitic loading across said plurality of ballast output stages (23) from phase locking the oscillating frequencies (f₁,f₂)

3. A lighting system, comprising:
a first ballast input stage (21) and a second ballast input stage (21), said first ballast input stage (21) operable to oscillate at a first oscillating frequency (f₁) and said second ballast input stage (21) operable to oscillate at a second oscillating frequency (f₂), the first oscillating frequency (f₁) and the second oscillating frequency (f₁) being dissimilar upon an initial powering of said first ballast input stage (21) and said second ballast input stage (21);
a first ballast output stage (23) and a second ballast output stage (23) connected in series, said first ballast output stage (23) in electrical communication with said first ballast stage (21) and said second ballast output stage (23) in electrical communication with said second ballast stage (21) to establish an open circuit voltage across said first ballast output stage (23) and said second ballast output stage (23) in response to an absence of a loading of a plurality of lamps (10) across said first ballast output stage (23) and said second ballast output stage (23),
wherein, subsequent to the initial powering of said first ballast input stage (21) and said second ballast input stage (21) and in response to the absence of the loading of the plurality of lamps (10) across said first ballast output stage (23) and said second ballast output stage (23), said first ballast output stage (23) and said second ballast output stage (23) impede any parasitic loading across said first ballast output stage (23) and said second ballast output stage (23) from phase locking the first oscillating frequency (f₁) and the second oscillating frequency (f₂).

4. The lighting system of claim 3,
wherein said first ballast output stage (23) includes a first tank resonant capacitor (C1a);
wherein said second ballast output stage (23) includes a second tank resonant capacitor (C1b); and
wherein, subsequent to the initial powering of said first ballast input stage (21) and said second ballast input stage (21) and in response to the absence of the loading of the plurality of lamps (10) across said first ballast output stage (23) and said second ballast output stage (23), a capacitive differential between said first tank resonant capacitor (C1a) and said second tank resonant capacitor (C1b) impedes any parasitic loading across said first ballast output stage (23) and said second ballast output stage (23) from phase locking the first oscillating frequency (f₁) and the second oscillating frequency (f₂).

5. The lighting system of claim 3,
wherein said first ballast output stage (23) includes a first primary winding (PW1a);
wherein said second ballast output stage (23) includes a second primary winding (PW1b); and
wherein, subsequent to the initial powering of said first ballast input stage (21) and said second ballast input stage (21) and in response to the absence of the loading of the plurality of lamps (10) across said first ballast output stage (23) and said second ballast output stage (23), an inductive differential between said first primary winding (PW1a) and said second primary winding (PW1b) impedes any parasitic loading across said first ballast output stage (23) and said second ballast output stage (23) from phase locking the first oscillating frequency (f₁) and the second oscillating frequency (f₂).

6. The lighting system of claim 3,
wherein said first ballast output stage (23) includes a first primary winding (PW1a) and a first at least one secondary winding (SW1-SW4) spaced from said first primary winding (PW1a) by a first air gap;
wherein said second ballast output stage (23) includes a second primary winding (PW1b) and a second at least one secondary winding (SW1-SW4) spaced from said first primary winding (PW1a) by a second air gap; and
wherein, subsequent to the initial powering of said first ballast input stage (21) and said second ballast input stage (21) and in response to the absence of the loading of the plurality of lamps (10) across said first ballast output stage (23) and said second ballast output stage (23), a differential between the first air gap and the second air gap impedes any parasitic loading across said first ballast output stage (23) and said second ballast output stage (23) from phase locking the first oscillating frequency (f₁) and the second oscillating frequency (f₂).

7. The lighting system of claim 3,
wherein said first ballast output stage (23) includes a first oscillator (22b) operating at the first oscillating frequency (f₁);
wherein said second ballast output stage (23) a second oscillator (22b) operating at the second oscillating frequency (f₂); and
wherein, subsequent to the initial powering of said first ballast input stage (21) and said second ballast input stage (21) and in response to the absence of the loading of the plurality of lamps (10) across said first ballast output stage (23) and said second ballast output stage (23), a differential between the first oscillating frequency (f₁) and the second oscillating frequency (f₂) is maintained by said first oscillator (22b) and said second oscillator (22b) to impede any parasitic loading across said first ballast output stage (23) and said second ballast output stage (23) from phase locking the first oscillating frequency (f₁) and the second oscillating frequency (f₂).
